(19) United States
(12) Patent Application Publication
(10) Pub. No.: US 2025/0168164 A1
(43) Pub. Date: May 22, 2025

(54) DEVICE VERIFICATION SYSTEM, DEVICE VERIFICATION METHOD, AND RECORDING MEDIUM

(71) Applicant: NEC Corporation, Minato-ku, Tokyo (JP)

(72) Inventor: Atsushi NAGATA, Tokyo (JP)

(73) Assignee: NEC Corporation, Minato-ku, Tokyo (JP)

(21) Appl. No.: 18/728,911

(22) PCT Filed: Jan. 31, 2022
(86) PCT No.: PCT/JP2022/003489

§ 371 Date: Jul. 15, 2024

(51) Int. Cl. H04L 9/40

(52) U.S. Cl. CPC H04L 63/0876; H04L 63/1425; H04L 63/1441

(57) ABSTRACT

The device verification system according to the present disclosure includes a plurality of devices and a communicator which manages the devices, wherein each of the plurality of devices includes a security function means, hash values of components and programs generated at the startup of each device are stored in each security function means, and the communicator comprises a verifying means that verifies the authenticity of each device at the startup on the basis of the hash values stored in the security function means and an output means that outputs the result of the verification.

### TECHNICAL FIELD

The present disclosure relates to a device verification system, a device verification method, and a recording medium.

### BACKGROUND ART

Cyber-attacks on devices (edge computers) installed in various work sites have become realistic. For example, when a system constructed by a system vendor is delivered to a customer, unauthorized falsification is performed on a device by a malicious third party, and the system may cause an abnormal operation.

On the other hand, it is known to verify authenticity of the device before starting the system in order not to execute an abnormal operation of the system. For example, PTL 1 discloses a technique in which, in a communication system including a device and a smart meter, an authentication request is made from the device to the smart meter, and data of the device is read after an authentication process is performed.

### CITATION LIST

### Patent Literature

PTL 1: JP 2016-039564 A

### SUMMARY OF INVENTION

### Technical Problem

However, the invention described in PTL 1 is verified using an external authentication server located away from the device. Accordingly, when the network with the external authentication server is blocked, the verification cannot be performed.

An object of the present disclosure is to provide a device verification system capable of verifying authenticity of a device until activation even when an external network is blocked.

### Solution to Problem

A device verification system according to the present disclosure is a device verification system including a plurality of devices and a communication device that manages the devices, in which each of the plurality of devices includes a security function means, a hash value of a component and a program generated at a time of activation of each of the devices is stored in the security function means, and the communication device includes a verification means for performing verification of authenticity of each of the devices at the time of activation based on the hash value stored in the security function means and an output means for outputting a result of the verification.

A device verification method according to an aspect of the present disclosure includes, by a communication device that manages a plurality of devices, performing verification of authenticity of each of the devices at a time of activation based on a hash value of a component and a program generated at a time of activation of each of the devices, the hash value being stored in a security function means of each of the plurality of devices, and outputting a result of the verification.

A recording medium according to one aspect of the present disclosure stores a program for causing a computer to execute performing verification of authenticity of each of devices at a time of activation based on a hash value of a component and a program generated at a time of activation of each of the devices, the hash value being stored in a security function means of each of a plurality of devices, and outputting a result of the verification.

### Advantageous Effects of Invention

An example of an effect of the present disclosure can provide a device verification system capable of verifying authenticity of a device until activation even when an external network is blocked.

### BRIEF DESCRIPTION OF DRAWINGS

FIG. 1 is a diagram illustrating a configuration of a device verification system according to a first example embodiment.

FIG. 2 is a diagram illustrating a hardware configuration in which devices and a communication device according to the first example embodiment are implemented by a computer device and its peripheral devices.

FIG. 3 is a flowchart illustrating an operation of the device verification system according to the first example embodiment.

FIG. 4 is a diagram illustrating a configuration of a device verification system according to a second example embodiment.

### EXAMPLE EMBODIMENTS

Next, example embodiments will be described in detail with reference to the drawings.

### First Example Embodiment

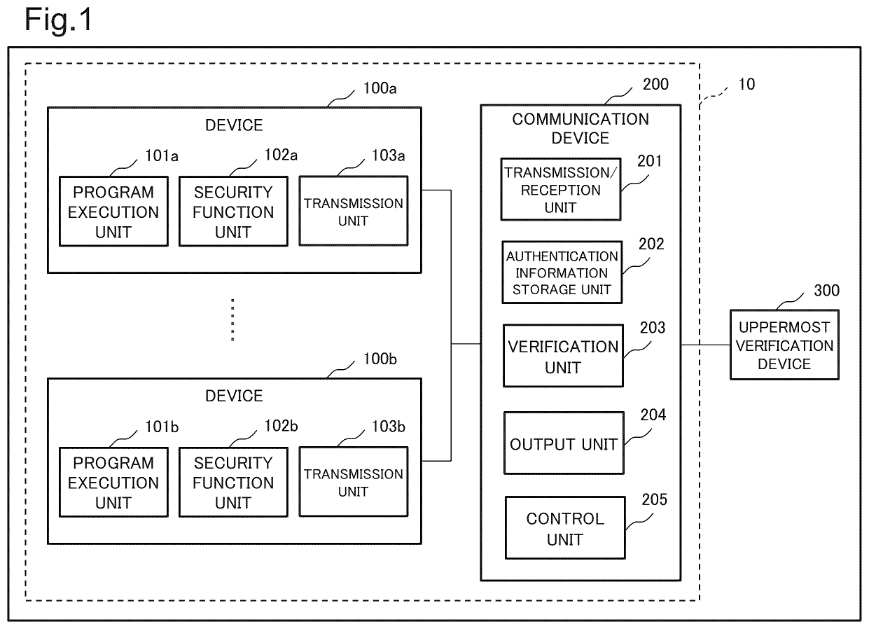

FIG. 1 is a diagram illustrating a configuration of a device verification system 10 according to a first example embodiment. Referring to FIG. 1, a device verification system 10 includes a plurality of devices 100 (100a and 100b) and a communication device 200. The device verification system 10 verifies authenticity in a series of startup operations up to program startup of the OS or the like started by power on or the like of each device 100. In the verification of authenticity in the present example embodiment, whether components of the device 100 or programs held by the device 100 have been falsified is verified by an upper authentication server based on a hash value calculated at the time of activation. In the present example embodiment, the communication device 200 verifies the authenticity of each device 100 by verifying an operation status for establishing a secure initial state by each device 100. The authenticity means a state in which only tested known components and programs are operating in each device 100, and unauthorized falsification is not performed in the device supply or system construction process. For example, the device verification system 10 verifies the device every time the startup operation of the device 100 is started.

The device verification system 10 is, for example, a system that becomes a closed environment when a network with a data center is interrupted, such as a system placed in a remote location. The device verification system 10 is, for example, an equipment system that controls equipment of a vehicle, a ship, an aircraft, or the like in real time. In the device verification system 10, the communication device 200 aggregates verification results of the devices 100 and transmits the results to an uppermost verification device 300 by using satellite communication or wireless communication. The communication device 200 may aggregate the verification results of the devices 100 and transmit the results to the uppermost verification device 300 via an upper verification device, which is not illustrated. In this case, the communication device 200 may further send the verification results sent from the devices 100 to the uppermost verification device 300 via another communication device 200 under management of the same upper verification device. In the case of the equipment system, the verification results may be transmitted to the uppermost verification device 300 via the upper verification device via the communication device 200 in another vehicle, ship, or aircraft by wireless communication. Examples of the other device verification system 10 include a system used in a connected car or an operational technology (OT) in a factory. That the upper verification device includes a verification unit that verifies the authenticity of the communication device 200 existing under the upper verification device. Similarly, the uppermost verification device 300 includes a verification unit that verifies the authenticity of the upper verification device existing below the uppermost verification device 300.

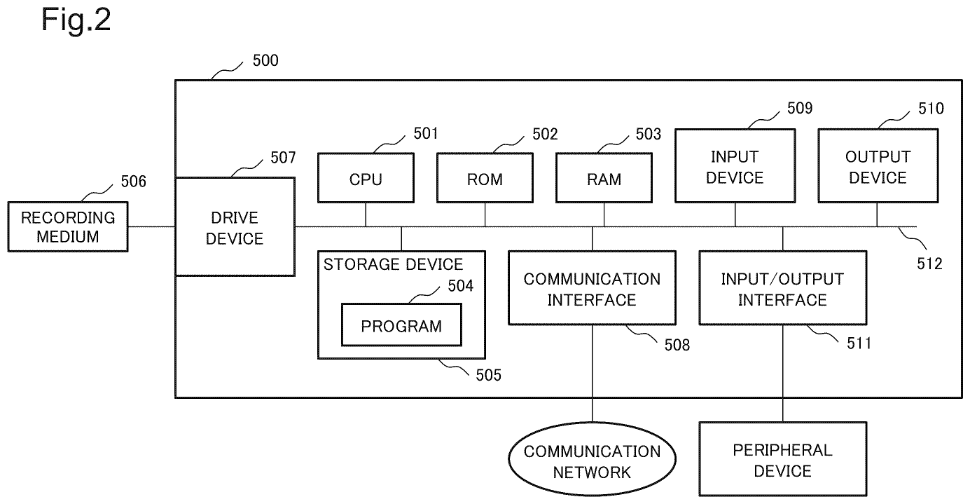

FIG. 2 is a diagram illustrating an example of a hardware configuration in which each of the device 100 and the communication device 200 according to the first example embodiment of the present disclosure is implemented by a computer device 500 including a processor. As illustrated in FIG. 2, each of the device 100 and the communication device 200 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data.

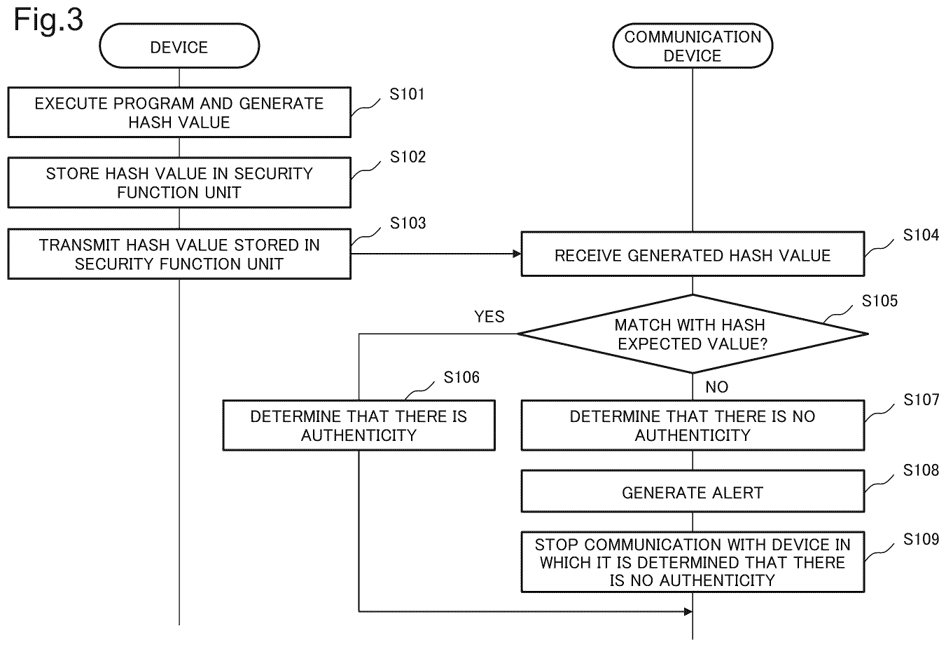

The CPU 501 controls the entire device 100 and the communication device 200 according to the first example embodiment of the present invention. The CPU 501 reads a program and data from a recording medium 506 mounted on, for example, a drive device 507 to a memory. The CPU 501 functions as a program execution unit 101, a security function unit 102, and a transmission unit 103 of the device 100 and a part thereof in the first example embodiment, and executes processing or a command in a flowchart illustrated in FIG. 3 to be described later based on the program. The CPU 501 functions as a transmission/reception unit 201, an authentication information storage unit 202, a verification unit 203, an output unit 204, and a control unit 205 of the communication device 200 and a part thereof in the first example embodiment, and executes processing or a command in the flowchart illustrated in FIG. 3 to be described later based on the program.

The recording medium 506 is, for example, an optical disk, a flexible disk, a magnetic optical disk, an external hard disk, a semiconductor memory, or the like. A part of the recording medium of the storage device is a non-volatile storage device, and records a program therein. The program may be downloaded from an external computer, not illustrated, connected to a communication network.

An input device 509 is implemented by, for example, a mouse, a keyboard, a built-in key button, and the like, and is used for an input operation. The input device 509 is not limited to a mouse, a keyboard, and a built-in key button, and may be, for example, a touch panel. An output device 510 is implemented by, for example, a display, and is used to confirm an output.

As described above, the first example embodiment illustrated in FIG. 1 is implemented by the computer hardware illustrated in FIG. 2. However, the means for implementing each unit included in the device 100 and the communication device 200 in FIG. 1 is not limited to the above-described configuration. Further, the communication device 200 may be implemented by one physically coupled device, or may be implemented by a plurality of devices by connecting two or more physically separated devices in a wired or wireless manner. For example, the input device 509 and the output device 510 may be connected to the computer device 500 via a network.

### <Device 100>

Each of the devices 100 (100a and 100b) includes a program execution unit 101 (101a or 101b), a security function unit 102 (102a or 102b), and a transmission unit 103 (103a or 103b). In the present example embodiment, the plurality of devices 100 is provided at two locations but is not limited thereto. The number of the plurality of devices 100 corresponds to the number of devices existing in the device verification system 10.

The program execution unit 101 executes a startup program of the device 100 and generates a hash value of the component and the program. For example, when the power of the device 100 is turned on, the program execution unit 101 executes programs in order of a boot loader, a basic input output system (BIOS) or unified extensible firmware interface (UEFI), and an OS. However, the configuration of the program to be executed is not limited thereto. Only the boot loader may exist in the program, or the boot loader itself may have multiple stages. When the program execution unit 101 generates the hash value of the component such as the CPU and the hash value of each program at the time of executing the startup program, the generated hash value is input to the security function unit 102. The hash value may be electronically signed to ensure authenticity of the hash value itself.

The security function unit 102 includes a storage area having tamper resistance. The security function unit 102 is an area that is difficult to be modified by a malicious third party. The security function unit 102 stores each hash value input from the program execution unit 101, and may have an encryption key necessary for an encryption process for securely transmitting the hash value to the communication device 200, or may have an attribute certificate defining an information transmission source. The security function unit 102 includes, for example, a trusted platform module (TPM), but is not limited thereto as long as the tamper resistance can be implemented. TPM has a characteristic that it is difficult to tamper with OS, hardware, or physical hacking from the outside, and thus has high tamper resistance.

The transmission unit 103 transmits the hash value stored in the security function unit 102 to the communication device 200 and requests verification of authenticity of the device 100.

### <Communication Device 200>

The communication device 200 includes the transmission/reception unit 201, the authentication information storage unit 202, the verification unit 203, the output unit 204, and the control unit 205. The communication device 200 may be configured by a single virtualization server operated as a plurality of servers.

The transmission/reception unit 201 receives data transmitted from the device 100 and transmits the data to the uppermost verification device 300. The transmission/reception unit 201 may have a firewall function in the device verification system 10. That is, the transmission/reception unit 201 determines whether to allow network communication with the outside of the device verification system 10, and permits or rejects the network communication.

The authentication information storage unit 202 stores components of each device 100 and a hash expected value of each program. The hash expected value is a hash value at a normal time generated in a case where the components and the startup program are not illegally falsified. The authentication information storage unit 202 stores in advance the hash expected value received from each device 100 via the transmission/reception unit 201.

The verification unit 203 verifies the authenticity of the components of each device 100 and the startup program executed by each device 100. The verification unit 203 determines, for example, with a binary value of whether authenticity is ensured. Upon receiving the verification request from any one of the devices 100, the verification unit 203 compares the hash value generated at the time of executing the startup program with the hash expected value stored in the authentication information storage unit 202. However, the verification method by the verification unit 203 is not limited thereto, and may be any method as long as it can confirm that the hash value at the time of execution of the startup program is the hash value at the normal time.

In a case where the hash value at the time of execution of the startup program is the same as the hash expected value, the verification unit 203 determines that there is authenticity and outputs the verification result to the output unit 204. In a case where the hash value at the time of execution of the startup program is different from the hash expected value, the verification unit 203 determines that there is no authenticity and outputs the verification result to the output unit 204 and the control unit 205. In a case where the hash value of any one of the devices 100 does not match the hash expected value, the verification unit 203 may determine that there is no authenticity at that time and output the verification result to the output unit 204 and the control unit 205.

The output unit 204 is a unit that outputs a result of authenticity of the device 100. The output unit 204 outputs the result of authenticity to the output device 510 such as a display device. In a case where the verification result indicating that there is no authenticity is received, the output unit 204 may notify that there is an abnormality by a lamp or a buzzer provided in the communication device 200. The output unit 204 may transmit the authenticity verification result to the uppermost verification device 300.

The control unit 205 stops communication with the device 100 in which it is determined that there is no authenticity by invalidating the certificate information. For example, the control unit 205 invalidates the attribute certificate of the device 100 in which it is determined that there is no authenticity using the mechanism of RFC 5055. The control unit 205 may perform control to reconfigure the device verification system 10 except for the device 100 in which it is determined that there is no authenticity and execute a shrinking operation of the device verification system 10.

The device verification system 10 only needs to include, as a minimum configuration, the security function unit 102 of the device 100, and the verification unit 203 and the output unit 204 of the communication device 200. In this case, the security function unit 102 may generate the hash value of the component of the device 100 and the hash value of the program executed by the device 100.

An operation of the device verification system 10 configured as described above will be described with reference to the flowchart of FIG. 3.

FIG. 3 is a flowchart illustrating an outline of an operation of the device verification system 10 according to the first example embodiment. The processing according to this flowchart may be executed based on program control by the processor described above.

As illustrated in FIG. 3, first, the program execution unit 101 of the device 100 executes the program, generates a hash value of the component of the device 100 and the program (step S101), and stores the generated hash value in the security function unit 102 (step S102). The transmission unit 103 transmits the hash value stored in the security function unit 102 to the communication device 200 (step S103). Next, the transmission/reception unit 201 of the communication device 200 receives the generated hash value (step S104). Next, the verification unit 203 compares the generated hash value with the hash expected value stored in the authentication information storage unit 202 (step S105). When the generated hash value matches the hash expected value (S105; YES), the verification unit 203 determines that there is authenticity (step S106), and the flow ends. On the other hand, when the generated hash value does not match the hash expected value (S105; NO), the verification unit 203 determines that there is no authenticity (step S107), and the output unit 204 generates an alert (step S108). Next, the control unit 205 stops communication with the device 100 in which it is determined that there is no authenticity (step S109). Thus, the device verification system 10 ends the device verification operation.

In the device verification system 10 according to the present example embodiment, the verification unit 203 of the communication device 200 verifies whether the hash value generated at the time of executing the startup program of the device 100 is the hash value at the normal time, thereby determining the authenticity. Thus, even if the network with the outside of the device verification system 10 is cut off, the authenticity of the device 100 until the OS is started can be verified.

Conventional commercially available virus software used for authenticity verification cannot be introduced depending on a program installed in the device 100. For example, in the case of a low-power device in which it is necessary to incorporate a power-saving designed OS such as an embedded OS as a mounted program, installing commercially available virus software is quite unfeasible from the viewpoint of performance and capacity. In the case of a device that burns a mounted program in a flash memory, it is difficult to install software itself. On the other hand, in the device verification system 10 of the present disclosure, the verification unit 203 in the communication device 200 verifies the authenticity of the device 100 based on the hash value of the component or the program of the device 100. Thus, the program can be introduced regardless of the program such as the installed OS.

### Second Example Embodiment

Next, a second example embodiment of the present disclosure will be described. Hereinafter, description of contents overlapping with the above description will be omitted to the extent that the description of the present example embodiment is not unclear. Similarly to the computer device illustrated in FIG. 2, each component in each example embodiment of the present disclosure can be implemented not only by hardware but also by a computer device or software based on program control.

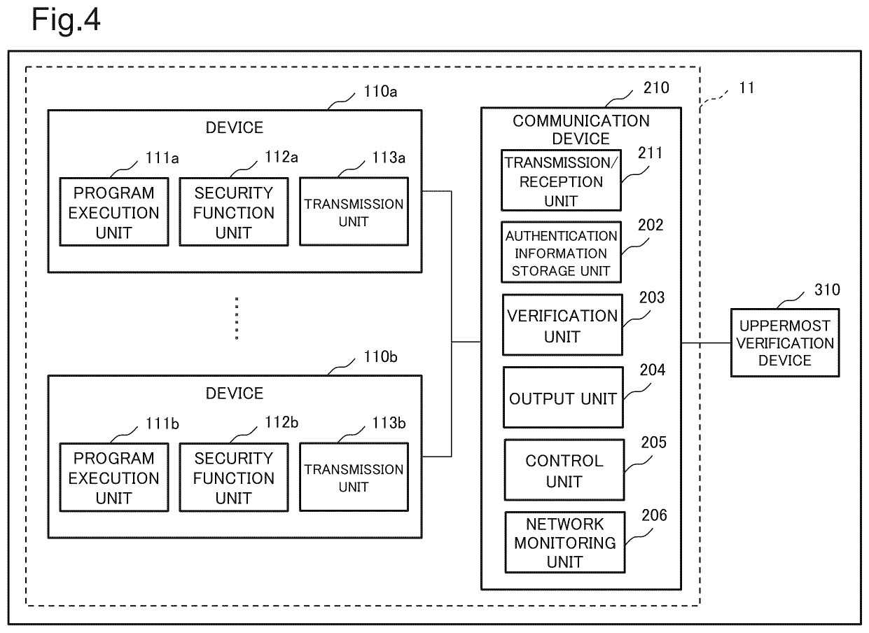

FIG. 4 is a diagram illustrating a configuration of a device verification system 11 according to the second example embodiment. With reference to FIG. 4, a device verification system 10 according to the second example embodiment will be described focusing on a part different from the device verification system 11 according to the first example embodiment. The device 110 has a configuration similar to that of the device 100. The communication device 210 includes a transmission/reception unit 211, the authentication information storage unit 202, the verification unit 203, the output unit 204, the control unit 205, and a network monitoring unit 206. That is, the present example embodiment is different from the first example embodiment in that the communication device 210 includes the network monitoring unit 206.

The network monitoring unit 206 in the second example embodiment monitors the network of the device verification system 11 when an application is executed after the OS is started. The network monitoring unit 206 verifies whether there is an abnormality in the network based on a difference from the operation pattern at the normal time of the device verification system 11. In the communication device 210, for example, a model generated by learning of operation data such as communication log information during a normal operation for a certain period (for example, 1 to 3 months) is stored in a storage device not illustrated. This model is a model that outputs whether the network is normal when operation data is input. When the network monitoring unit 206 senses an operation different from the operation pattern at the normal time using this model, an alert is issued through the output unit 204.

In the second example embodiment of the present disclosure, the network monitoring unit 206 verifies whether the network of the device verification system 11 is abnormal at the time of execution of the application based on a difference from the operation pattern at the normal time. Thus, unknown malware that cannot be detected by antivirus software can be detected. The network monitoring unit 206 can detect, for example, an abnormality due to falsification of the dynamic link library when the application of the device 110 is executed. In the device verification system 11 in which the control of the application is narrowed down to a specific operation like the equipment system, it is easy to extract feature points of the operation pattern. Thus, the accuracy of network abnormality detection by the network monitoring unit 206 can be improved. When the second example embodiment is combined with the first example embodiment of the present disclosure, it is possible to detect an abnormality both at the time of activation and during operation of the device 110.

While the present invention has been particularly illustrated and described with reference to example embodiments thereof, the invention is not limited to these example embodiments. It will be understood by those of ordinary skill in the art that various changes in form and details may be made therein without departing from the spirit and scope of the present invention as defined by the claims.

For example, although the plurality of operations is described in order in the form of a flowchart, the order of description does not limit the order of executing the plurality of operations. Thus, when each example embodiment is implemented, the order of the plurality of operations can be changed within a range that does not interfere in content.

### REFERENCE SIGNS LIST

10, 11 device verification system
100, 110 device
101, 111 program execution unit
102, 112 security function unit
103, 113 transmission unit
200, 210 communication device
201, 211 transmission/reception unit
202, 212 authentication information storage unit
203, 213 verification unit
204, 214 output unit
205, 215 control unit
216 network monitoring unit
300, 310 uppermost verification device

What is claimed is:

1. A device verification system including a plurality of devices and a communication device that manages the devices, wherein
each of the plurality of devices includes a security function unit, a hash value of a component and a program generated at a time of activation of each of the devices is stored in the security function unit, and
the communication device comprising:
a memory storing instructions; and
at least one processor configured to execute the instructions to:
perform verification of authenticity of each of the devices at the time of activation in accordance with the hash value stored in the security function unit, and
output a result of the verification.

2. The device verification system according to claim 1, wherein the security function unit includes a storage area having tamper resistance.

3. The device verification system according to claim 1, wherein the at least one processor is further configured to execute the instructions to:
verify authenticity at the time of activation of the device by comparing the hash value with a hash expected value stored in advance.

4. The device verification system according to claim 1, wherein the at least one processor is further configured to execute the instructions to:
in a case where there is a device in which it is determined that there is no authenticity, notify that there is an abnormality in the device.

5. The device verification system according to claim 1, wherein the at least one processor is further configured to execute the instructions to:
invalidate an attribute certificate of a device in which it is determined that there is no authenticity to stop communication with the device in which it is determined that there is no authenticity.

6. The device verification system according to claim 1, wherein the at least one processor is further configured to execute the instructions to:
in a case where there is a device in which it is determined that there is no authenticity, transmit that there is an abnormality in the device to an uppermost verification device via an upper verification device.

7. The device verification system according to claim 1, wherein the at least one processor is further configured to execute the instructions to:
monitor a network of the device verification system when an application is executed; and
verify whether the network is abnormal in accordance with a difference from an operation pattern at a normal time of the device verification system.

8. A device verification method comprising:
by a communication device that manages a plurality of devices,
the step of performing verification of authenticity of each of the devices at a time of activation in accordance with a hash value of a component and a program generated at a time of activation of each of the devices, the hash value being stored in a security function unit of each of the plurality of devices; and
the step of outputting a result of the verification.

9. A non-transitory recording medium that stores a program for causing a computer to execute:
the step of performing verification of authenticity of each of devices at a time of activation in accordance with a hash value of a component and a program generated at a time of activation of each of the devices, the hash value being stored in a security function unit of each of a plurality of devices; and
the step of outputting a result of the verification.

10. The device verification method according to claim 8, wherein the security function unit includes a storage area having tamper resistance.

11. The device verification method according to claim 8, further comprising the step of verifying authenticity at the time of activation of the device by comparing the hash value with a hash expected value stored in advance.

12. The device verification method according to claim 8, further comprising the step of notifying that there is an abnormality in the device in a case where there is a device in which it is determined that there is no authenticity.

13. The device verification method according to claim 8, further comprising the step of invalidating an attribute certificate of a device in which it is determined that there is no authenticity to stop communication with the device in which it is determined that there is no authenticity.

14. The device verification method according to claim 8, further comprising the step of transmitting that there is an abnormality in the device to an uppermost verification device via an upper verification device in a case where there is a device in which it is determined that there is no authenticity.

15. The device verification method according to claim 8, further comprising the step of monitoring a network of the device verification system when an application is executed; and
the step of verifying whether the network is abnormal in accordance with a difference from an operation pattern at a normal time of the device verification system.

16. The non-transitory recording medium according to claim 9, wherein the security function unit includes a storage area having tamper resistance.

17. The non-transitory recording medium according to claim 9, further comprising the step of verifying authenticity at the time of activation of the device by comparing the hash value with a hash expected value stored in advance.

18. The non-transitory recording medium according to claim 9, further comprising the step of notifying that there is an abnormality in the device in a case where there is a device in which it is determined that there is no authenticity.

19. The non-transitory recording medium according to claim 9, further comprising the step of invalidating an attribute certificate of a device in which it is determined that there is no authenticity to stop communication with the device in which it is determined that there is no authenticity.

20. The non-transitory recording medium according to claim 9, further comprising the step of transmitting that there is an abnormality in the device to an uppermost verification device via an upper verification device in a case where there is a device in which it is determined that there is no authenticity.

21. The non-transitory recording medium according to claim 9, further comprising the step of monitoring a network of the device verification system when an application is executed; and
the step of verifying whether the network is abnormal in accordance with a difference from an operation pattern at a normal time of the device verification system.
